(19) United States
(12) Patent Application Publication
(10) Pub. No.: US 2026/0340252 A1
(43) Pub. Date: Oct. 29, 2026

(54) METHOD, SYSTEM, AND CIRCUIT SIMULATION APPARATUS FOR DETECTING HIGH-IMPEDANCE NODES

(71) Applicant: PRIMARIUS TEHCNOLOGIES CO., LTD., Shanghai (CN)

(72) Inventor: Yihui LI, Shanghai (CN)

(73) Assignee: PRIMARIUS TEHCNOLOGIES CO., LTD., Shanghai (CN)

(21) Appl. No.: 19/701,892

(22) Filed: Jun. 9, 2026

Related U.S. Application Data
(63) Continuation of application No. PCT/CN2024/136173, filed on Dec. 2, 2024.

(30) Foreign Application Priority Data
Dec. 13, 2023 (CN) 2023117194677

(51) Int. Cl. G06F 30/373; G06F 119/06

(52) U.S. Cl. CPC G06F 30/373; G06F 2119/06

(57) ABSTRACT

The application discloses a method, a system, a circuit simulation apparatus, and a non-transitory computer-readable storage medium for detecting high-impedance nodes. The method comprises: obtaining a conduction matrix generated during circuit simulation, wherein each row and each column of the conduction matrix corresponds to a node, and a matrix element with a first identification value indicates that the node corresponding to the row and the node corresponding to the column are conductive; based on the conduction matrix, classifying nodes that are mutually conductive into a same group, and individually classifying nodes that have no conductive node into separate groups, so as to obtain a plurality of node groups; and from the plurality of node groups, determining the node group containing a reference node as a non-high-impedance group, and all other node groups as high-impedance groups. This method quickly identifies high-impedance nodes in transient simulation, reducing computational cost and detection time.

### CROSS REFERENCE TO RELATED APPLICATION

This application is a Continuation of PCT Patent Application No. PCT/CN2024/136173 filed on Dec. 02, 2024, which claims priority of China Patent Application No. 2023117194677 filed on Dec. 13, 2023. The contents of the above-identified applications are incorporated herein by reference.

### TECHNICAL FIELD

This application relates to the field of circuit simulation technologies, and more particularly to a method, system, circuit simulation apparatus, and non-transitory computer-readable storage medium for detecting high-impedance nodes.

### BACKGROUND

A high-impedance node refers to a node whose resistance to a circuit ground node is extremely large (e.g., greater than 10¹² Ω) at a certain instant during circuit operation. A high-impedance node is electrically isolated from other circuit nodes; consequently, its voltage value is uncontrollable and random. When high-impedance nodes are connected to the gates of field-effect transistors (FETs) to control other circuits, this can easily lead to random behavior in the controlled circuits, thereby reducing the accuracy and reliability of simulation results for circuit modules in which the high-impedance nodes reside. High-impedance nodes in circuits may be caused by switching of circuit operating states or circuit design defects, and their detection is a critical task in circuit simulation verification. Conventional high-impedance detection techniques are based on circuit connectivity and device conduction states, starting from one node, and determining whether a conductive path exists to the reference ground node. If no conductive path exists, the node is identified as a high-impedance node.

In conventional methods, a high-impedance node detection process needs to select one node as the starting node, and then detects whether the currently selected node is the high-impedance node by traversing all possible conductive paths and judging whether it can reach the ground node. Specifically, pin-to-pin resistance value of each circuit component is calculated. If the resistance value between two pins drops below a threshold, the corresponding pins are considered conductive, indicating that a conductive path exists between their connected nodes. In this way, all the node pairs having conductive paths can be identified. The conventional detection algorithms start from an initial node and verify if there exists a conductive path to other nodes. If such a path exists, the algorithms continue to search for new nodes until all the connected nodes are fully traversed. If no reference ground node is found among these connected nodes, the algorithms determine that the initial starting node and all nodes connected therewith are high-impedance nodes. To judge whether all nodes in the circuit are high-impedance nodes, the above detection process shall be performed on every node. As a result, the algorithms involve a large amount of computation and have low efficiency. Moreover, performing node-by-node detection during transient simulation consumes substantial time and greatly increases the overall circuit simulation duration.

### SUMMARY

In view of the foregoing description, the present application provides a method, a system, a circuit simulation apparatus, and a non-transitory computer-readable storage medium for detecting high-impedance nodes, so as to solve the problems of large computational volume and low efficiency in conventional high-impedance node detection methods.

The application provides a method for detecting high-impedance nodes, comprising:

Obtaining a conduction matrix generated during circuit simulation, wherein each row and each column of the conduction matrix corresponds to a node, and a matrix element with a first identification value indicates that the node corresponding to the row and the node corresponding to the column are conductive;

Based on the conduction matrix, classifying nodes that are mutually conductive into a same group, and individually classifying nodes that have no conductive node into separate groups, so as to obtain a plurality of node groups; and

From the plurality of node groups, determining at least one node group containing a reference node as a non-high-impedance group, and all other node groups as high-impedance groups.

Optionally, obtaining the conduction matrix generated during the circuit simulation comprises: obtaining node conduction states corresponding to each node at each simulation time instant during the circuit simulation; and updating the conduction matrix based on the node conduction states to obtain an updated conduction matrix in real time at a detection timing.

Optionally, updating the conduction matrix based on the node conduction states comprises: identifying nodes with changed conduction states to obtain updated nodes based on the node conduction states; and updating values of corresponding matrix elements in the conduction matrix according to conduction states of the updated nodes at a corresponding simulation time instant.

Optionally, before obtaining the node conduction states corresponding to each node at each simulation time instant, obtaining the conduction matrix generated during the circuit simulation comprises: constructing an initial conduction matrix, and updating the initial conduction matrix based on the node conduction states at a first simulation time instant to obtain the conduction matrix for the first simulation time instant.

Optionally, all matrix elements in the initial conduction matrix are initialized to a second identification value.

Optionally, the first identification value is 1, and the second identification value is 0.

Optionally, the reference node comprises a reference ground node.

The application further provides a system for detecting high-impedance nodes, the system comprising:

An obtaining module, configured to obtain a conduction matrix generated during circuit simulation, wherein each row and each column of the conduction matrix corresponds to a node, and a matrix element with a first identification value indicates that the node corresponding to the row and the node corresponding to the column are conductive;

A classifying module, configured to, based on the conduction matrix, classify nodes that are mutually conductive into a same group, and individually classify nodes that have no conductive node into separate groups, so as to obtain a plurality of node groups; and

A determination module, configured to, from the plurality of node groups, determine at least one node group containing a reference node as a non-high-impedance group, and all other node groups as high-impedance groups.

The application further provides a circuit simulation apparatus comprising a memory and a processor, wherein the memory stores a detection program for high-impedance nodes, and the processor executes the detection program for high-impedance nodes, to perform the steps of any one of the above methods for detecting high-impedance nodes.

The application further provides a non-transitory computer-readable storage medium storing a computer program, wherein the computer program is executed by a processor to perform the steps of any one of the above methods for detecting high-impedance nodes.

The method, system, circuit simulation apparatus, and non-transitory computer-readable storage medium for detecting high-impedance nodes disclosed above can be performed during circuit simulation: the conduction matrix recording the conduction states among all the nodes in the simulated circuit is obtained; based on the conduction matrix, the nodes that are mutually conductive are grouped together, while other nodes having no conductive node are individually grouped, whereby the plurality of node groups are obtained; and at least one group containing the reference ground node is classified as a non-high-impedance group, whereas all other groups are classified as high-impedance groups. Accordingly, all nodes in each high-impedance group are thus high-impedance nodes. This allows for quickly identifying high-impedance nodes of the simulated circuit at each simulation time instant, reducing computational complexity in the high-impedance node detection process, improving detection efficiency, and reducing total detection time.

Further, the above detection method for high-impedance nodes can adopt incremental updating to update the conduction matrix in real time at each simulation time instant, which reduces the computation load during the updating process. Meanwhile, high-impedance nodes in the simulated circuit can be detected in real time based on the updated conduction matrix, so as to further improve the timeliness of high-impedance node detection.

### BRIEF DESCRIPTION OF THE DRAWINGS

To facilitate a clearer illustration of the technical solutions in the embodiments of the application, the drawings referenced in the description of the embodiments will be briefly introduced below. It is evident that the drawings described below represent only certain embodiments of the present application. For those skilled in the art, additional drawings may be derived from these drawings without inventive effort.

FIG. 1 illustrates a flowchart of a method for detecting high-impedance nodes according to an embodiment of the application;

FIG. 2 illustrates a schematic structural diagram of a conduction matrix according to an embodiment of the application;

FIGS. 3A, 3B, and 3C are schematic structural diagrams of conduction matrices according to another embodiment of the application;

FIG. 4 is a schematic structural diagram of a system for detecting high-impedance nodes according to an embodiment of the application.

### DETAILED DESCRIPTION OF THE EMBODIMENTS

The technical solutions in the embodiments of the application will be clearly and completely described below with reference to the accompanying drawings. Obviously, the described embodiments are merely part of the embodiments of the application, rather than all embodiments. Based on the embodiments of the application, all other embodiments obtained by those skilled in the art without creative efforts shall fall within the protection scope of this application. Where there is no conflict, the various embodiments described below and the technical features thereof can be combined with one another.

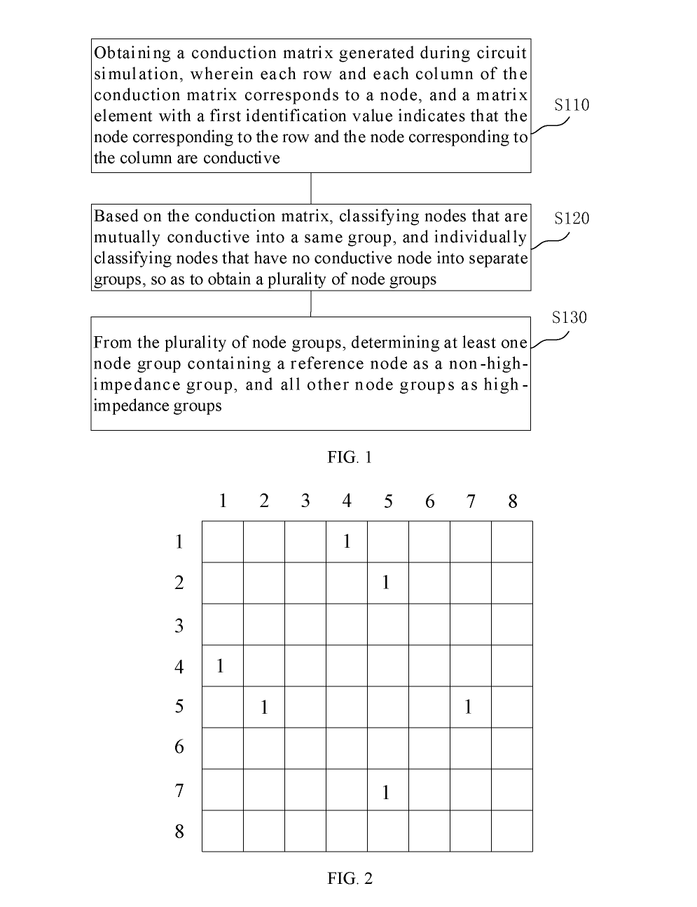

In a first aspect, the application provides a method for detecting high-impedance nodes, executable on a terminal device configured for circuit simulation, such as a circuit simulation apparatus. As shown in FIG. 1, the method includes steps S110 to S130.

S110: obtaining a conduction matrix generated during circuit simulation, wherein each row and each column of the conduction matrix corresponds to a node, and a matrix element with a first identification value indicates that the node corresponding to the row and the node corresponding to the column are conductive.

Optionally, the first identification value may be a non-zero value, for example, the integer 1. When the first identification value is set to 1, the conduction matrix is as shown in FIG. 2; the conduction matrix records the conduction states among nodes 1 to 8 in the simulated circuit. As shown in FIG. 2, the matrix elements at row 1 column 4 and row 4 column 1 are both set to 1, indicating the first node and the fourth node of the simulated circuit are conductive at a corresponding simulation time instant. The matrix elements at row 5 column 2 and row 2 column 5 are both set to 1, indicating the fifth node and the second node of the simulated circuit are conductive at the corresponding simulation time instant; and the matrix elements at row 5 column 7 and row 7 column 5 are both set to 1, indicating the fifth node and the seventh node of the simulated circuit are conductive at the corresponding simulation time instant. Furthermore, in the conduction matrix, the matrix elements between two nodes having no conductive relationship may be set to an identification value other than the first identification value, so that the node conduction state between corresponding nodes can be rapidly determined based on values of the matrix elements.

S120: based on the conduction matrix, classifying nodes that are mutually conductive into a same group, and individually classifying nodes that have no conductive node into separate groups, so as to obtain a plurality of node groups.

Specifically, step S120 identifies mutually conductive nodes based on the values of matrix elements in the conduction matrix, and classifies such nodes into the same group, while individually classifies each node having no conductive node into separate groups, thereby obtaining a plurality of node groups. Taking the conduction matrix illustrated in FIG. 2 as an example, the node classifying process will be described in detail. Based on the matrix element values of the conduction matrix shown in FIG. 2, the first node and the fourth node are grouped together; the second node, the fifth node, and the seventh node are grouped together; and each of the remaining nodes forms its own group, thereby obtaining the plurality of node groups.

S130: from the plurality of node groups, determining at least one node group containing a reference node as a non-high-impedance group, and all other node groups as high-impedance groups. The nodes contained within the high-impedance groups are identified as high-impedance nodes.

Optionally, the reference node includes a reference ground node or other nodes used to define a high-impedance state in the simulated circuit.

As described above, the method for detecting high-impedance nodes can be performed during circuit simulation: the conduction matrix recording the conduction states among all the nodes in the simulated circuit is obtained; based on the conduction matrix, the nodes that are mutually conductive are grouped together, while other nodes having no conductive node are individually grouped, whereby the plurality of node groups are obtained; and at least one group containing the reference ground node is classified as a non-high-impedance group, whereas all other groups are classified as high-impedance groups. Accordingly, all nodes in each high-impedance group are thus high-impedance nodes. This method can quickly identify high-impedance nodes of the simulated circuit at a corresponding simulation time instant, reduce computational complexity in the high-impedance node detection process, improve detection efficiency and reduce total detection time.

In one embodiment, obtaining a conduction matrix generated during circuit simulation comprises: obtaining node conduction states corresponding to each node at each simulation time instant during the circuit simulation; updating the conduction matrix based on the node conduction states to obtain an updated conduction matrix in real time at a detection timing; classifying nodes in the simulated circuit into a plurality of node groups according to the values of the matrix elements in the updated conduction matrix, determining at least one node group containing a reference node as a non-high-impedance group, and all other node groups as high-impedance groups, so as to detect high-impedance nodes in the simulated circuit in real time. Optionally, in this embodiment, electrical signals such as currents between respective nodes may be obtained during the simulation. If the current between two nodes is greater than a predetermined current threshold, the two nodes are determined to be conductive. On the contrary, if the current is less than or equal to the predetermined current threshold, the two nodes are determined to be electrically disconnected (i.e., non-conductive).

Optionally, the above “detection timing” refers to the timing when high-impedance node detection needs to be performed, which can be determined according to the detection requirements input by a user, such as at least one simulation time instant set by the user.

Furthermore, the circuit simulation apparatus can update the conduction matrix at each simulation time instant, extract the updated conduction matrix, and identify and detect high-impedance nodes in the simulated circuit based on the extracted conduction matrix, so as to realize real-time detection of such high-impedance nodes in the simulated circuit. According to the detection results of high-impedance nodes obtained at multiple continuous simulation time instants, the circuit simulation apparatus can identify risky paths in the simulated circuit and further analyze characteristics such as relevant performance of the simulated circuit.

In an exemplary implementation, updating the conduction matrix based on the node conduction states comprises: identifying nodes with changed conduction states to obtain updated nodes based on the node conduction states; and updating the values of corresponding matrix elements in the conduction matrix according to conduction states of the updated nodes at a corresponding simulation time instant, so that the updated conduction matrix can accurately represent the conduction states of respective nodes in the simulated circuit at the corresponding simulation time instant. This embodiment adopts incremental updating, that is, only nodes with changed conduction states are updated, which can reduce the calculation amount in the updating process.

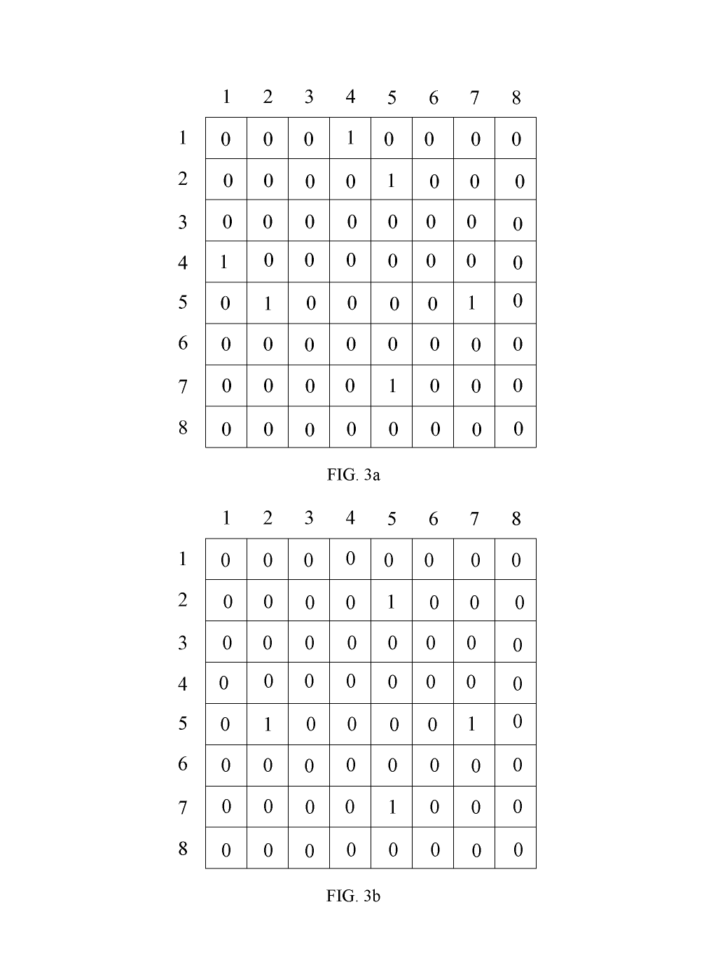

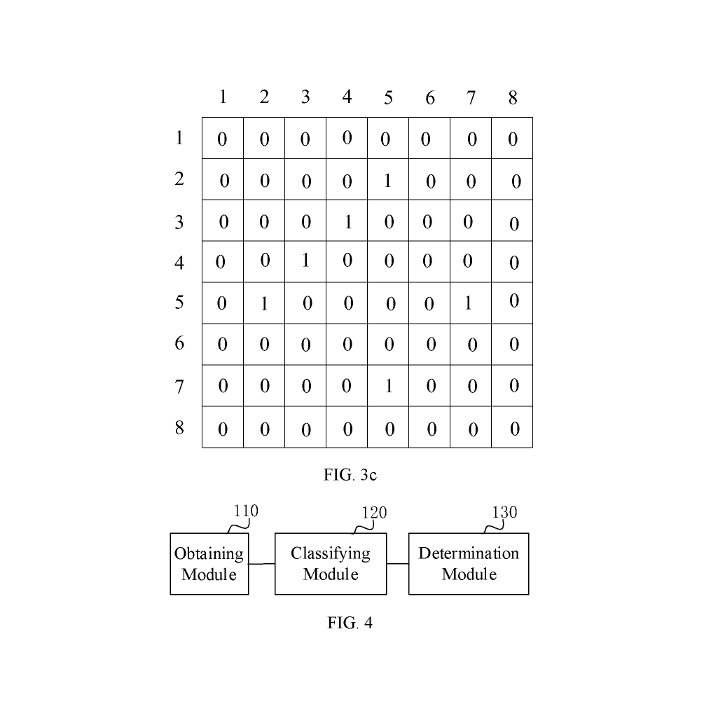

Specifically, when a matrix element is a second identification value, it indicates that the node corresponding to the row and the node corresponding to the column are non-conductive. Updating the values of corresponding matrix elements in the conduction matrix according to conduction states of the updated nodes at a corresponding simulation time instant comprises: if two nodes change from a conduction state to a non-conduction state, the corresponding matrix elements of the two nodes in the conduction matrix shall be modified from the first identification value to the second identification value. If two nodes change from a non-conduction state to a conduction state, the corresponding matrix elements of the two nodes shall be adjusted from the second identification value to the first identification value. The first identification value is 1, and the second identification value is 0. The conduction matrix at a previous simulation time instant is illustrated in FIG. 3A. At the current simulation time instant, if the conduction state between the first node and the fourth node changes to a non-conduction state, the matrix elements corresponding to row 1 column 4 and row 4 column 1 are updated from 1 to 0 as shown in FIG. 3B. Additionally, at the current simulation time instant, if the non-conduction state between the third node and the fourth node changes to a conduction state, the matrix elements corresponding to row 3 column 4 and row 4 column 3 are updated from 0 to 1 as shown in FIG. 3C.

In another exemplary implementation, before the step of obtaining node conduction states of respective nodes during the simulation at each simulation time instant, obtaining the conduction matrix generated during the circuit simulation comprises: constructing an initial conduction matrix, and updating the initial conduction matrix based on the node conduction states at a first simulation time instant to obtain the conduction matrix for the first simulation time instant. Accordingly, at a second simulation time instant, the conduction matrix at the first simulation time instant can be updated according to the corresponding node conduction states to obtain a conduction matrix for a second simulation time instant. Similarly, the conduction matrix of the previous simulation time instant is updated based on the node conduction states at subsequent simulation time instants. The corresponding conduction matrix is obtained in real time at each simulation time instant, and high-impedance nodes in the simulated circuit are detected in real time according to the obtained conduction matrix.

Optionally, all matrix elements of the initial conduction matrix are initialized to the second identification value, which indicates that every two corresponding nodes are non-conductive. Wherein the first identification value is 1 and the second identification value is 0, so that the values of matrix elements can more simply and intuitively present the node conduction state between every two nodes.

As described above, the method for detecting high-impedance nodes can be performed during circuit simulation: the conduction matrix recording the conduction states among all the nodes in the simulated circuit is obtained; based on the conduction matrix, the nodes that are mutually conductive are grouped together, while other nodes having no conductive node are individually grouped, whereby the plurality of node groups are obtained; and at least one group containing the reference ground node is classified as a non-high-impedance group, whereas all other groups are classified as high-impedance groups. Accordingly, all nodes in each high-impedance group are thus high-impedance nodes. This allows for quickly identifying high-impedance nodes of the simulated circuit at corresponding simulation time instants, reducing computational complexity in the high-impedance node detection process, improving detection efficiency, and reducing total detection time. Further, the above detection method for high-impedance nodes can adopt incremental updating to update the conduction matrix in real time at each simulation time instant, which reduces the computation load during the updating process. Meanwhile, high-impedance nodes in the simulated circuit can be detected in real time based on the updated conduction matrix, so as to further improve the timeliness of high-impedance node detection.

The inventor has conducted a comparative analysis between the high-impedance node detection method provided in the application and conventional detection algorithms. It is found that under the same test conditions, the detection speed of the application is increased by more than three times while maintaining consistent detection results. Therefore, the application can effectively improve the detection efficiency.

In a second aspect, the application further provides a system for detecting high-impedance nodes, implementable within a circuit simulation apparatus. As shown in FIG. 4, the system comprises:

An obtaining module 110, configured to obtain a conduction matrix generated during circuit simulation, wherein each row and each column of the conduction matrix corresponds to a node, and a matrix element with a first identification value indicates that the node corresponding to the row and the node corresponding to the column are conductive;

A classifying module 120, configured to, based on the conduction matrix, classify nodes that are mutually conductive into a same group, and individually classify nodes that have no conductive node into separate groups, so as to obtain a plurality of node groups; and

A determination module 130, configured to, from the plurality of node groups, determine at least one node group containing a reference node as a non-high-impedance group, and all other node groups as high-impedance groups.

Specific implementation details of the system correspond directly to those described above with respect to the method for detecting high-impedance nodes and are therefore incorporated by reference herein. Each module in the system may be implemented wholly or partially in software, hardware, or a combination thereof. Modules may be embedded within or external to the computing module of the related computing device in the form of hardware; alternatively, they may reside as executable instructions in the computing device’s memory, callable by the computing module to execute the operations corresponding to the above modules in the system.

The application further provides a circuit simulation apparatus comprising a memory and a processor, wherein the memory stores a detection program for high-impedance nodes, and the processor is configured to execute the detection program to perform the steps of the method for detecting high-impedance nodes according to any of the above embodiments.

The application further provides a non-transitory computer-readable storage medium, storing a computer program, wherein the computer program is executed by a processor to perform the steps of the method for detecting high-impedance nodes according to any of the above embodiments.

Although the application has been described with reference to one or more exemplary embodiments, those skilled in the art will appreciate, based on the present specification and drawings, that various equivalent modifications and variations are possible. Such modifications and variations fall within the scope of the application and are governed solely by the appended claims. Specifically, with regard to the functions performed by the components described herein, the terms used to describe such components are intended to correspond, unless otherwise indicated, to any component capable of performing the specified function of the described component (e.g., that is functionally equivalent), even if not structurally equivalent to the disclosed structure that performs the function in the exemplary implementations of the specification shown herein.

That is, the above descriptions are merely embodiments of the application and are not intended to limit the scope of the disclosure. Any equivalent structure or process transformation derived from the specification and drawings—including combinations of technical features across embodiments or any direct or indirect application in related technical fields, falls equally within the scope of protection defined by the appended claims.

Additionally, in the description of the application, it is to be understood that terms such as “center,” “longitudinal,” “transverse,” “length,” “width,” “thickness,” “top,” “bottom,” “front,” “back,” “left,” “right,” “vertical,” “horizontal,” “upper,” “lower,” “inner,” and “outer” refer to orientations or positional relationships as depicted in the accompanying drawings. These terms are used solely for convenience in describing the application and simplifying the description, and do not indicate or imply that the apparatus or elements referred to must have a particular orientation, and thus should not be construed as limiting the application. Moreover, for structural elements having the same or similar characteristics, the application may assign identical or distinct reference numerals for identification. Furthermore, the terms such as “first” and “second” are used for descriptive purposes only and are not to be understood as indicating or implying relative importance or implicitly indicating the quantity of the technical features so designated. Thus, a feature designated as “first” or “second” explicitly or implicitly encompasses one or more such features. In the description of the application, “plurality” means two or more, unless otherwise expressly and specifically defined.

In the application, the term “exemplary” is employed to denote “serving as an example, illustration, or explanation.” An embodiment described as “exemplary” is not necessarily preferred over others or inherently superior. To enable any person skilled in the art to make and use the application, the foregoing description provides sufficient disclosure. For explanatory purposes, various details have been included herein. It will be appreciated that those skilled in the art may implement the application without employing these specific details. In alternative embodiments, well-known structures and processes have been omitted from the description to avoid obscuring the core teachings with unnecessary detail. Accordingly, the application is not limited to the embodiments shown but is intended to encompass the broadest scope consistent with the principles and features disclosed herein.

1. A method for detecting high-impedance nodes, comprising:
obtaining a conduction matrix generated during circuit simulation, wherein each row and each column of the conduction matrix corresponds to a node, and a matrix element with a first identification value indicates that the node corresponding to the row and the node corresponding to the column are conductive;
based on the conduction matrix, classifying nodes that are mutually conductive into a same group, and individually classifying nodes that have no conductive node into separate groups, so as to obtain a plurality of node groups; and
from the plurality of node groups, determining the node group containing a reference node as a non-high-impedance group, and all other node groups as high-impedance groups.

2. The method according to claim 1, wherein obtaining the conduction matrix generated during the circuit simulation comprises:
obtaining node conduction states corresponding to each node at each simulation time instant during the circuit simulation; and
updating the conduction matrix based on the node conduction states to obtain an updated conduction matrix in real time at a detection timing.

3. The method according to claim 2, wherein updating the conduction matrix based on the node conduction states comprises:
identifying nodes with changed conduction states to obtain updated nodes based on the node conduction states; and
updating values of corresponding matrix elements in the conduction matrix according to conduction states of the updated nodes at a corresponding simulation time instant.

4. The method according to claim 2, wherein before obtaining the node conduction states corresponding to each node at each simulation time instant, obtaining the conduction matrix generated during the circuit simulation comprises:
constructing an initial conduction matrix, and updating the initial conduction matrix based on the node conduction states at a first simulation time instant to obtain the conduction matrix for the first simulation time instant.

5. The method according to claim 4, wherein all elements in the initial conduction matrix are initialized to a second identification value.

6. The method according to claim 5, wherein the first identification value is 1, and the second identification value is 0.

7. The method according to claim 5, wherein the reference node comprises a reference ground node.

8. A circuit simulation apparatus for detecting high-impedance nodes, comprising:
a memory, configured to store a detection program; and
a processor, configured to execute the detection program to perform a method for detecting high-impedance nodes comprising:
obtaining a conduction matrix generated during circuit simulation, wherein each row and each column of the conduction matrix corresponds to a node, and a matrix element with a first identification value indicates that the node corresponding to the row and the node corresponding to the column are conductive;
based on the conduction matrix, classifying nodes that are mutually conductive into a same group, and individually classifying nodes that have no conductive node into separate groups, so as to obtain a plurality of node groups; and
from the plurality of node groups, determining the node group containing a reference node as a non-high-impedance group, and all other node groups as high-impedance groups.

9. The circuit simulation apparatus according to claim 8, wherein obtaining the conduction matrix generated during the circuit simulation comprises:
obtaining node conduction states corresponding to each node at each simulation time instant during the circuit simulation; and
updating the conduction matrix based on the node conduction states to obtain an updated conduction matrix in real time at a detection timing.

10. The circuit simulation apparatus according to claim 9, wherein updating the conduction matrix based on the node conduction states comprises:
identifying nodes with changed conduction states to obtain updated nodes based on the node conduction states; and
updating values of corresponding matrix elements in the conduction matrix according to conduction states of the updated nodes at a corresponding simulation time instant.

11. The circuit simulation apparatus according to claim 9, wherein before obtaining the node conduction states corresponding to each node at each simulation time instant, obtaining the conduction matrix generated during the circuit simulation comprises:
constructing an initial conduction matrix, and updating the initial conduction matrix based on the node conduction states at a first simulation time instant to obtain the conduction matrix for the first simulation time instant.

12. The circuit simulation apparatus according to claim 11, wherein all elements in the initial conduction matrix are initialized to a second identification value.

13. The circuit simulation apparatus according to claim 12, wherein the first identification value is 1, and the second identification value is 0.

14. The circuit simulation apparatus according to claim 12, wherein the reference node comprises a reference ground node.

15. A non-transitory computer-readable storage medium, configured to store a computer program, wherein the computer program is configured to be executed by a processor to perform a method for detecting high-impedance nodes comprising:
obtaining a conduction matrix generated during circuit simulation, wherein each row and each column of the conduction matrix corresponds to a node, and a matrix element with a first identification value indicates that the node corresponding to the row and the node corresponding to the column are conductive;
based on the conduction matrix, classifying nodes that are mutually conductive into a same group, and individually classifying nodes that have no conductive node into separate groups, so as to obtain a plurality of node groups; and
from the plurality of node groups, determining the node group containing a reference node as a non-high-impedance group, and all other node groups as high-impedance groups.

16. The non-transitory computer-readable storage medium according to claim 15, wherein obtaining the conduction matrix generated during the circuit simulation comprises:
obtaining node conduction states corresponding to each node at each simulation time instant during the circuit simulation; and
updating the conduction matrix based on the node conduction states to obtain an updated conduction matrix in real time at a detection timing.

17. The non-transitory computer-readable storage medium according to claim 16, wherein updating the conduction matrix based on the node conduction states comprises:
identifying nodes with changed conduction states to obtain updated nodes based on the node conduction states; and
updating values of corresponding matrix elements in the conduction matrix according to conduction states of the updated nodes at a corresponding simulation time instant.

18. The non-transitory computer-readable storage medium according to claim 16, wherein before obtaining the node conduction states corresponding to each node at each simulation time instant, obtaining the conduction matrix generated during the circuit simulation comprises:
constructing an initial conduction matrix, and updating the initial conduction matrix based on the node conduction states at a first simulation time instant to obtain the conduction matrix for the first simulation time instant.

19. The non-transitory computer-readable storage medium according to claim 18, wherein all elements in the initial conduction matrix are initialized to a second identification value.

20. The non-transitory computer-readable storage medium according to claim 19, wherein the reference node comprises a reference ground node.
